(19) United States
(12) Patent Application Publication
(10) Pub. No.: US 2015/0316419 A1
(43) Pub. Date: Nov. 5, 2015

(54) METHOD AND APPARATUS FOR MONITORING BODY TEMPERATURE AND ACTIVITY

(71) Applicant: SEENATH PUNNAKKAL, FORT WORTH, TX (US)

(72) Inventor: SEENATH PUNNAKKAL, FORT WORTH, TX (US)

(21) Appl. No.: 14/269,130

(22) Filed: May 3, 2014

(51) Int. Cl. G01K 1/02; G01K 1/14; G01K 3/08; G01K 13/00

(52) U.S. Cl. CPC G01K 1/02; G01K 13/002; G01K 1/14; G01K 3/08

(57) ABSTRACT

Absolute body temperature measurement is not easy to obtain. The temperature probe has to be placed in body cavities or swallowed to get core body temperature. The skin temperature usually has no relation to core temperature making it impossible to use in wearable devices. The present invention measures body temperature differences to monitor body temperature changes due to fever to generate alarms if needed. The invention is also useful in monitoring body temperature change due to exercise, that can be used to calculate the calories burned during the exercise session, activity and sleep.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The invention relates to the field of wearable sensor devices attached to an animal, including human, body and signaling certain conditions for detection by observers like humans or a camera integrated computer such as in a contemporary ‘smartphone’.

### BACKGROUND OF THE INVENTION

The monitoring of fever episodes is the main use of the current invention. To get core body temperature is very difficult unless you use a probe that is inserted to body cavities. This is good if you only need to monitor temperature once in a while. There are temperature changing stickers that you can use. It is not all that accurate and you need to keep watching it to know what is going on and visibility is poor at night. Skin temperature is usually dependent on sweating, air temperature, body temperature, blood circulation, body extremities and other parameters. So typical sensors on skin is not a good indicator of core body temperature.

Body temperature rise from exertion is not normally taken care of in a normal electronic or chemical temperature sensors. This adds another layer of error in the reading.

Typical electronic monitoring thermometers suffer from battery capacity when transmitting temperature continuously over wireless networks making them bulky or having to recharge them often.

### BRIEF SUMMARY OF THE INVENTION

The apparatus and method disclosed is based on the idea of detecting temperature changes and not absolute temperature. This allows the use of skin temperature as a gauge for core temperature variation. This can be used to generate alarms in certain situations. For example, your child is still sick with 102 degree F. (measured with a body cavity thermometer) viral fever at 10 pm. You just gave him fever-reducing medicine. You do not typically know if the child's fever is still high or lower from that time to the time for next dose which is typically 4-6 hours from 10 pm. The only way around it is you do not sleep, wake the child up from time to time and measure temperature. If the temperature is still rising, you need to give him medication earlier, apply cold head patches or even take the child to emergency hospital to prevent brain damage.

To allow for skin temperature variation to be used as a proxy for core body temperature, it needs to be used in the head, chest or back areas. Care is taken to isolate the sensor from the environment and trap the heat in an air pocket where the sensor is situated. It is also based on the idea that the sensor is in the form of an adhesive patch that attaches to the body, is removable and re-usable after adhesive change. An accelerometer is used to detect activity and correct for temperature errors due to exertion. The battery can also be replaced when needed. The temperature change is also communicated to observers, human or computer with camera, by LED's and Audio output. This allows the observer to see the LED status or hear the alarm sounds depending on temperature change magnitude.

A software running on a contemporary smartphone with a camera is able to detect the change in LED colors and rate of flashing to determine temperature change. This may also be achieved using audio signaling or light signaling. These methods can be used to send temperature and acceleration data to the smartphone software. The software on the smartphone can then call another phone or ring out the alarm or send messages. Another way to send data is using the 3-wire serial port on the sensor patch. This is used to physically be connected to the Bluetooth adapter to transfer data logged in the sensor patch non-volatile memory to the smartphone.

The accelerometer on the sensor patch can be used as a standalone activity tracker too. Since the sensor patch can be used on the back or chest, they can be easily used as a better sleep detector than the ones on the market that needs lot of data processing to determine sleep condition or pressing a button when you go to sleep. Similarly the sensor patch on the thigh can detect and track sitting detection very well to provide sitting monitoring as this effects the health a lot. This is not available in wrist worn devices like Jawbone wrist band or Mobile phone activity sensor. A typical wrist based sensor like the one described in prior art, Fitbit US Patent Application Publication Pub. No. US2014/0088922A1, the acceleration sensor is worn on the wrist and does not have any unique axis at or near full scale acceleration due to gravity in sleeping or sitting or walking movements. Consequently you need user input to signal sleep or significant processing algorithm to detect activities. This leads to often incorrect data. The sensor patch provides a way to position itself for optimum activity detection.

In summary these are the unique parts of this invention:

a unique temperature difference based fever monitoring and alarm;

a unique positioning and sealing of the flexible temperature sensor package and the skin area related;

re-usable sensor package with adhesive pad change and coin cell change;

the sensor package can be attached to different parts of the body for appropriate activity detection. Attach to calf for running detection for example;

accelerometer based temperature correction for activity related temperature rise;

calorie expenditure calculation during exercise;

direct visibility of LED warning signals and audio alarm;

ideal fever and antipyretic medicine temperature cycle monitoring; extended battery life due to deep sleep mode and lack of a bluetooth or radio wireless device on board;

unique powered bluetooth module with its own power and connected to sensor package only when data is download without reducing sensor battery life;

unique software to pair to a computer such as contemporary smartphone using LED color signaling. The software can also work with existing non-electronic temperature sensor strips that change color with temperature;

unique software to pair to a computer such as contemporary smartphone using audio FSK signaling.

ability to track basal temperature in the morning just before waking up to monitor conditions like hyperthyroidism based on accelerometer sleep detection and temperature change data logged to memory.

### BRIEF DESCRIPTION OF THE SEVERAL VIEWS OF THE DRAWING

FIG. 1A shows internals of one embodiment of the invention, where 100 is the sensor package that can be attached to the human body or clothing. 110 is the acceleration and gyroscopic sensor integrated circuit packages. 120 is a temperature sensor that sends the temperature of the sensor as an analog voltage output to the analog to digital converter (ADC) of the microcontroller 130 for temperature measurement. 140 represent power source, which in this embodiment is a 3v coin cell. 150 is the Non-Volatile data storage area and 160 the software area within the microcontroller 130. 170 is an audio output buzzer. 180 is the array of color LED's. Both the LED's 180 and buzzer 170 are used to signal temperature conditions and data communication with smartphones.

The FIGS. 1B, IC and 10 shows different places on the body where the temperature sensor package 100 may be placed. Position in FIG. 1D is suitable only for monitoring how much sitting and actual walk the user gets.

FIG. 2A shows the top view of an embodiment of the complete sensor package. Item 200 is the coin cell holder. Item 210 is the mechanical switch. 220 represents the color LED array. 230 represents the microcontroller. 240 shows the buzzer.

FIG. 2B shows the side view of the sensor package. 280 shows the transparent RTV filled area. 290 shows the pcb assembly. 270 shows the disposable adhesive layer that can be replaced for re-use of the rest of the package

FIG. 2C shows the bottom side of the sensor package. 250 shows the temperature sensor position and 260 shows the air pocket it forms with the skin to preserve heat for the temperature sensor. 270 shows the disposable adhesive layer that can be replaced for re-use of the rest of the package

FIG. 3 shows the use of a bluetooth adapter 304 to collect stored data from the sensor 300 detached from the body and its copper strip edge 302 is inserted to the connector 303 on the adapter 304. Switch 301 is used in a timed hold down to start data download. The data is put out by the sensor 300 through its serial port in 302 and the adapter 304 transmits that data wirelessly to a computer device 305 it is authorized to connect to.

### DETAILED DESCRIPTION OF THE INVENTION

While the making and using of various embodiments of the present disclosure are discussed in detail below, it should be appreciated that the present disclosure provides many applicable inventive concepts, which can be embodied in a wide variety of specific contexts. The disclosure is primarily described and illustrated hereinafter in conjunction with various embodiments of the presently-described systems and methods. The specific embodiments discussed herein are, however, merely illustrative of specific ways to make and use the disclosure and do not limit the scope of the disclosure.

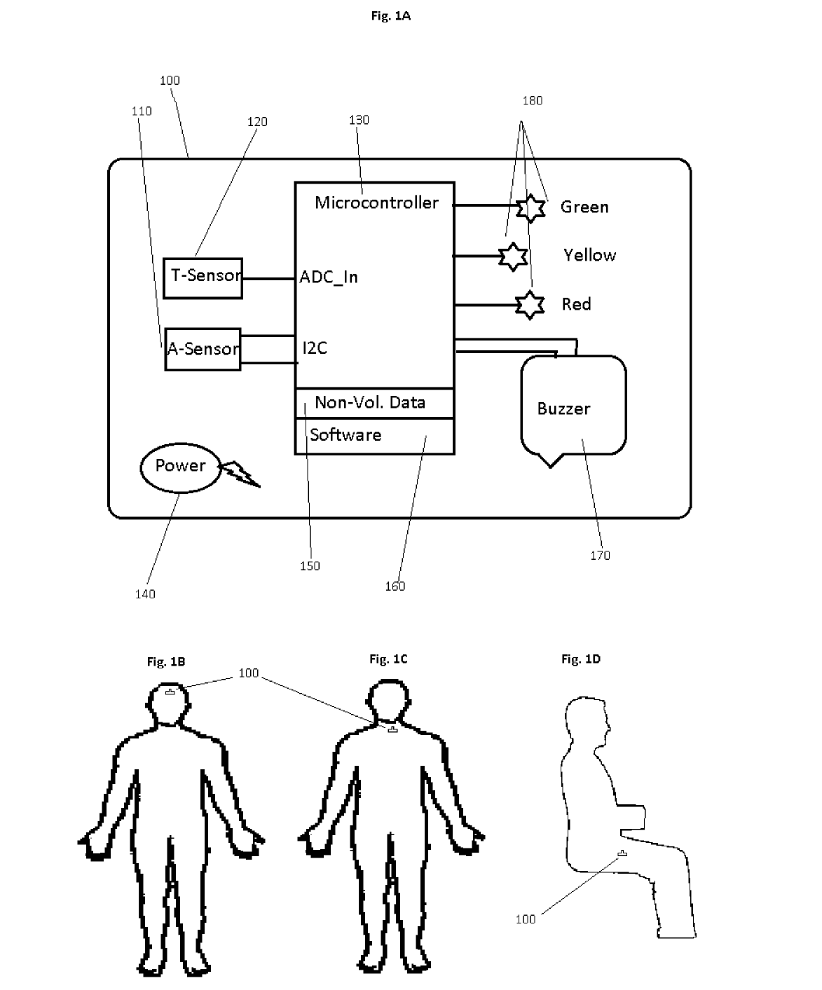

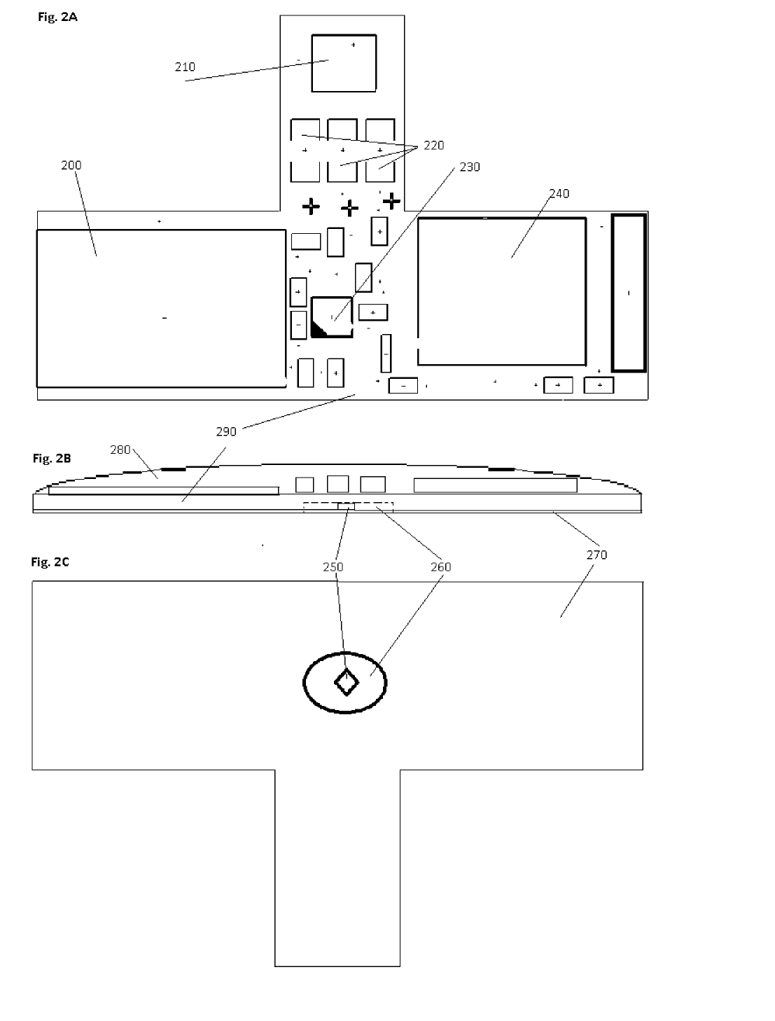

Conceptual block diagram in FIG. 1A shows one embodiment of the internals of the sensor package. It has a temperature sensor Integrated circuit (IC) 120 that works well in the temperature range of animal body temperature range. It also has an accelerometer IC with 3 axis sensing and a gyroscope for rotation sensing 110. A low-cost microcontroller 130 is the heart of the system. It has reserved some space in the flash memory for non-volatile memory 150. Some of the memory is used by the software (firmware) 160 instead. There are three LED's 180 in this embodiment, green, red and yellow. There is also a 170 buzzer on the board. FIG. 2A show flexible printed circuit assembly top view, an embodiment of the invention as built for test. FIG. 2B shows a side view of the sensor package assembly of FIG. 2A. FIG. 2C shows the bottom side of the sensor package of FIG. 2A.

The microcontroller 230 puts the sensor assembly of FIG. 2A to deep sleep most of the time. When the user pushes the switch key 210, the microcontroller 230 is interrupted and wakes up and monitors the switch press count with a periodicity of 200 mS. If the switch continues to be pressed and then released during a majority of 10 such 200 mS interrupts, a ‘turn on’ condition is detected. Typically the user would place the sensor package on a kid's forehead and then ‘turn ‘on’ the sensor. Similarly this 200 mS timer is used to detect 5 s and 10 second button presses. The 10 second key press 210 is seen as a signal to upload data from the sensor package of FIG. 2A. A 5 second key press 210 and release is seen as deep sleep condition with long battery life in lieu of actual turn off of the device.

As soon as it is ‘turned on’, the microcontroller 230 reads the temperature from sensor 250 as analog data input on the microcontroller 230 analog input. The microcontroller 230 wakes up on a periodic timer every minute and takes a reading for the next 5 minutes. The average of these 5 reading is taken as a ‘reference temperature’ reading and is stored in flash data memory as such. The microcontroller 230 then enters its deep sleep mode to save power.

Once ‘reference temperature’ is taken, the microcontroller 230 wakes up every minute. The microcontroller 230 acquires a new temperature reading. The default yellow LED 180 flashes at 1 Hz rate a couple of times. This reading is compared against the reference every single time this happens. In this embodiment the temperature change limits are considered ±0.25° C., ±0.50° C., ±0.75° C. and ±1.00° C.

If the [new temperature−reference temperature>0 and within ±0.25° C.] the yellow LED 180 flashes at 2 Hz a couple of times.

If the [new temperature−reference temperature>0.25° C. and <0.50° C.] the red LED 180 flashes at 1 Hz a couple of times.

If the [new temperature−reference temperature>0.50° C. and <0.75° C.] the red LED flashes at 2 Hz a couple of times.

If the [new temperature−reference temperature>0.75° C.] the red LED flashes at 3 Hz a couple of times. The buzzer is turned on for 15 seconds.

If the [new temperature−reference temperature<−0.25 and >−0.50] the green LED 180 flashes at 1 Hz rate.

If the [new temperature−reference temperature<−0.50] the green LED flashes at 2 Hz rate.

The microcontroller 230 also reads the position of the four accelerometer 110 axes using an I2C interface. The microcontroller 230 stores the data current temperature and accelerometer data in the microcontroller non-volatile data memory.

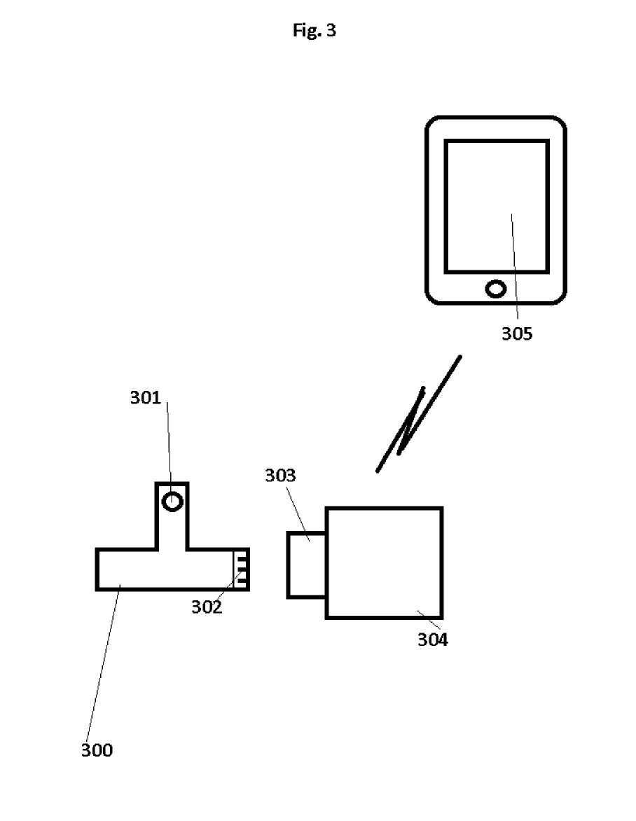

As described in section [0018] an upload signal from key 210 press of 10 seconds starts the download operation. The sensor package basically transmits the reference temperature data, temperature and accelerometer data paired according to the order they were saved in the non-volatile memory. This signal is transmitted via the UART Rx, Tx and Gnd lines as shown in connector 302 of FIG. 3. The UART to bluetooth adapter 304 has a connector 303 that will accept the sensor package 301, connector 302.

In another embodiment of the invention, there is no need for a bluetooth adapter to transfer data to a computer device 305. The software running on the sensor package codes the data to be transmitted during temperature and accelerometer data collection timer events or during upload of entire logged data, into color coded LED colors. The number of bits in each word will depend on the number of LED's 180 available on the device. The color coded data is set on the LED's for a word for a 20 mS, then blanked for the next 13 mS. Then the next word to be transmitted is loaded to the LED's 180 and the process continues till all data is sent. The software running on 305 wakes up when the sensor package LED's are ready to be sent, except the for the first time when the camera and software on the computer device has to be on all the time. Other times, these parts can be sent to low power mode. The said software then opens the camera and captures images at a rate of 30 fps. The images are processed with opencv computer vision library to detect edges of the boundaries (contour) of individual LED's. Then each of the contour area is checked for validity to LED contour sizes and typical LED contour shapes. Then the color of each contour is determined using opencv library functions. Once a whole frame is processed we have reconstructed a word. This is written to a file and the frame is discarded to save memory. This is continued to the end of the data and the said file on device 305 will now have the data transmitted from the sensor package 300 to the computer device 305. The same image processing technique is used to generate alarms and calls to other phones in case of a particular alarm temperature condition. The above described technique is particularly attractive when sending small amounts of data wirelessly.

In another embodiment, the software running on a computing device 305 like a smartphone or tablet or a computer device can use its camera or USB camera to detect non-electronic type temperature color-changing stickers and their color change to generate alarms or calls to alert parents.

In another embodiment of the invention the data transfer between the sensor package 300 and the computer device is through the buzzer audio output. The data to be transmitted from sensor package 300 is coded in frequency shift keying (FSK)modulation and the software running on the smartphone 305 constantly computes the FFT or Goertzel algorithm to detect the signal frequency coming in and converts the bit frames to data. The data is used for further processing for alarm generation or calorie expenditure calculation or activity monitoring.

Once the computer 305 has uploaded the accelerometer data and temperature data it can correct for body temperature rise due to fever from error due to body temperature rise due to activity. The calorie expenditure is calculated from the temperature difference before exercise and temperature measured after exercise and local environmental temperature from weather server. The acceleration data is used to determine activity and position to determine the correctness of temperature based measurement. The duration and intensity of the activity from accelerometer data is used to calculate approximate calorie expenditure during the period.

The invention claimed is:

1. A method and apparatus for monitoring and giving feedback to users about changes in body temperature during episodes of fever, exercise session and hypothyroidism condition without the need for absolute core body temperature measurement comprising:
electronics assembly on a flexible printed circuit board further comprising:
plurality of Light Emitting Diodes in a plurality of colors;
buzzer;
coin cell power supply;
microcontroller with data memory;
mechanical switch;
temperature sensor and 3-axis and rotation accelerometer sensor;
hypoallergenic adhesive pad with a small hole, onto which the said
electronic assembly is attached such that the said hole exposes the sensor case to users assembly is attached such that the said hole exposes the sensor assembly encloses a small air pocket between the sensor and the users body area to prevent heat loss from that area;
a flexible cover on top of the flexible printed circuit assembly to protect it while allowing replacement of battery and light and sound emission;
and method comprising the steps of:
attaching the said adhesive pad to the user's body;
holding down the said switch for a few seconds and releasing it;
the above action causes the orange LED to blink intermittently for a minute while the microcontroller gathers the reference temperature reading average from the temperature sensor, this value is stored in the microcontroller's non-volatile memory;
the microcontroller then wakes up from sleep every fixed minute interval and pairs and logs the temperature and accelerometer reading in the microcontroller's non-volatile memory;
if the read temperature is above the reference temperature, switch to flashing red LED at a rate proportional to the difference in current temperature from said reference temperature;
similarly the green LED is flashed at a rate proportional to the difference in current temperature from said reference temperature in case the current temperature is lower than the said reference.

2. The apparatus of claim 1 attached to chest, in its vertical position, to distinguish between real body activity, sleeping position and waking up from sleep. This accelerometer data is paired with the said temperature data before storage or transmission.

3. The apparatus of claim 1 attached to top of the thigh, detects sitting inactivity, when top of the thigh is nearly parallel to floor in the sitting position. This accelerometer data is paired with the said temperature data before storage or transmission.

4. The wireless method of data transmission from the apparatus of claim 1 to a computing device comprising:
coding the data to be transmitted in plurality of LED's of plurality of colors, with each color occupying places from least significant bit to the most significant bit;
said coded data is sent to the LED's to transmit for a pre-defined frame duration for a fixed number of frames. This is initiated for one set of reading every fixed few minutes;
to transmit complete logged data stored in non-volatile memory, the user holds down the said switch for 10 seconds;
the software running on the said computing device uses its camera to capture at the said frame duration, processes the images with the image processing library to detect LED's and their colors for each frame and convert the colors back to the original data frame by frame;
the software keeps the camera off between periods of data transmission to save power;
the software then reconstruct the temperature and acceleration data for charting.

5. The wireless method of data transmission from the said buzzer of apparatus of claim 1 to a computing device comprising:
coding the data for transmission using Frequency Shift Keying (FSK) method;
the said coded data is sent to the said buzzer to be transmitted as sound;
this is initiated for one set of reading every few fixed minutes;
the software running on the said computing device uses its microphone to capture sound coming from the said buzzer;
the software then decodes and reconstruct the temperature and accelerometer data for charting;

6. The said software running on computer device of claim 5, uses the said paired accelerometer and temperature data, to calculate the excess energy expended for exercise session, from the said temperature difference data, local air temperature and humidity data pulled from weather server.

7. The said software running on computer device of claim 4, uses the said paired accelerometer and temperature data, to determine wake up basal body temperature data related body temperature change from the data downloaded from the said apparatus.

8. An apparatus and method to allow uploading large amount of data from a body adhering sensor device to a computing device, while not taking power from said body attached sensor, comprising;
3 copper strips for receiving line, transmit line and ground line of a serial interface on the flex printer circuit board edge,
a bluetooth adapter which is battery powered with connector to plug in the said flex printed circuit board edge containing the said conductive strips and,
said bluetooth adapter taking in the serial data from the said sensor flexible PCB connector and wirelessly transmitting the data to any device that has rights to connect to the bluetooth adapter.

9. A method of using software running on a computing device to capture image of non-electronic temperature dependent color changing strip, using computer vision to determine strip location and then its color and numbers on it, to monitor temperature conditions of the wearer of the strip wirelessly with no contact.
